(19) United States
(12) Patent Application Publication
(10) Pub. No.: US 2018/0091660 A1
(43) Pub. Date: Mar. 29, 2018

(54) CONTENT SHARING METHOD AND DEVICE, AND MEDIUM

(71) Applicant: Beijing Xiaomi Mobile Software Co., Ltd., Beijing (CN)

(72) Inventors: Zhenzhou LU, Beijing (CN); Yin ZHU, Beijing (CN); Qiaozhuo CHEN, Beijing (CN)

(21) Appl. No.: 15/615,837

(22) Filed: Jun. 7, 2017

(30) Foreign Application Priority Data
Sep. 29, 2016 (CN) 201610865379.1

(51) Int. Cl. H04N 1/00; G06F 3/0486; G06Q 50/00

(52) U.S. Cl. CPC H04N 1/00209; G06Q 50/01; G06F 3/0486

(57) ABSTRACT

A content sharing method, device and medium are provided. According to some embodiments, when a screen capturing operation instruction is detected, a current display page is captured and a screenshot corresponding to the current display page is generated; a preview picture corresponding to the screenshot is generated and the preview picture is display at a preset position of a display screen; it is detected whether a user switches to a preset page on which a preset application is displayed; when the preset page on which the preset application is displayed currently runs, it is detected whether the user performs a dragging operation on a displayed preview picture, and if it is detected that the user performs the dragging operation on the preview picture, the preview picture is moved and displayed according to the dragging operation; and if it is detected that the preview picture is moved to a target position of the preset page, a sharing operation is performed on the screenshot.

### CROSS-REFERENCE TO RELATED APPLICATIONS

This application is filed based upon and claims priority to Chinese Patent Application No. 201610865379.1, filed on Sep. 29, 2016, the entire contents of which are incorporated herein by reference.

### TECHNICAL FIELD

The present disclosure generally relates to the technical field of mobile Internet, and more particularly, to a content sharing method, device, and medium.

### BACKGROUND

Along with rapid development of mobile Internet technology, particularly emergence of social media, users may share opinions, ideas, experiences and viewpoints with others anytime anywhere through a social media platform. The users may share information together with pictures, so that shared contents are more visual. Typically, a user may select a target picture to be used from a locally stored picture base when the user shares information together with a picture through a social media platform. When a user is reading a certain information page and is intended to share the read information page, the information page is usually captured and stored in a local picture base, and then a captured screenshot is selected from the picture base for sharing on a social media platform. As such, sharing operation is relatively more troublesome.

### SUMMARY

According to a first aspect of the embodiments of the present disclosure, a content sharing method is provided, and the method includes: when a screen capturing operation instruction is detected, a current display page is captured, and a screenshot corresponding to the current display page is generated; a preview picture corresponding to the screenshot is generated, and the preview picture is displayed at a preset position of a display screen; it is detected whether a user switches to a preset page on which a preset application is displayed; when the preset page on which the preset application is displayed currently runs, it is detected whether the user performs a dragging operation on the displayed preview picture; if it is detected that the user performs the dragging operation on the preview picture, the preview picture is moved and displayed according to the dragging operation; and if it is detected that the preview picture is moved to a target position of the preset page, a sharing operation is performed on the screenshot.

According to a second aspect of the embodiments of the present disclosure, a content sharing device is provided and the device includes: a processor; and a memory configured to store instructions executable by the processor, wherein the processor is configured to: when a screen capturing operation instruction is detected, capture a current display page, and generate a screenshot corresponding to the current display page; generate a preview picture corresponding to the screenshot, and display the preview picture at a preset position of a display screen; detect whether a user switches to a preset page on which a preset application is displayed; when the preset page on which the preset application is displayed currently runs, detect whether the user performs a dragging operation on the displayed preview picture; if it is detected that the user performs the dragging operation on the preview picture, move and display the preview picture according to the dragging operation; and if it is detected that the preview picture is moved to a target position of the preset page, perform a sharing operation on the screenshot.

According to a third aspect of the embodiments of the present disclosure, a non-transitory computer-readable storage medium having stored therein instructions that, when executed by a processor of a terminal, causes the terminal to perform a content sharing method, and the method includes: when a screen capturing operation instruction is detected, capturing a current display page, and generating a screenshot corresponding to the current display page; generating a preview picture corresponding to the screenshot, and displaying the preview picture at a preset position of a display screen; detecting whether a user switches to a preset page on which a preset application is displayed; detecting whether the user performs a dragging operation on the displayed preview picture when the preset page on which the preset application is displayed currently runs; if it is detected that the user performs the dragging operation on the preview picture, moving and displaying the preview picture according to the dragging operation; and if it is detected that the preview picture is moved to a target position of the preset page, performing a sharing operation on the screenshot.

It should be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart showing a content sharing method according to an exemplary embodiment.

FIG. 2 is a flow chart showing a content sharing method according to an exemplary embodiment.

FIG. 3 is a schematic diagram illustrating previewing of a screenshot on a display screen of a terminal according to an exemplary embodiment.

FIGS. 4A to 4E are schematic diagrams illustrating an implementation process of sharing a screenshot in a contact session page according to an exemplary embodiment.

FIGS. 5A to 5D are schematic diagrams illustrating an implementation process of sharing a screenshot in a call record according to an exemplary embodiment.

FIGS. 6A to 6C are schematic diagrams illustrating an implementation process of sharing a screenshot in a memo according to an exemplary embodiment.

FIG. 7 is a block diagram of a content sharing device according to an exemplary embodiment.

FIG. 8 is a block diagram of a content sharing device according to an exemplary embodiment.

FIG. 9 is a block diagram of a content sharing device according to an exemplary embodiment.

By the accompanying drawings, definite embodiments of the present disclosure have been shown, and more detailed descriptions will be made hereinafter. These accompanying drawings and text descriptions are not intended to limit the scope of the concept of the present disclosure in any manner but to describe the concept of the present disclosure for those skilled in the art with reference to specific embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

Terms used in the present disclosure are not intended to limit the present disclosure but only to describe a purpose of a specific embodiment. The terms “A”, “said” and “the”, used in the present disclosure and the appended claims, indicating a singular form are also intended to include a plural form unless other meanings are clearly represented in the context. It also should be understood that the term “and/or” used in the present disclosure refers to and includes any or all possible combinations of one or more associated listed items.

It should be understood that various kinds of information may be described by adopting the terms such as first, second and third in the present disclosure, but the information should not be limited to these terms. These terms are only adopted to distinguish the information of the same type from each other. For example, without departing from the scope of the present disclosure, first information may also be called second information, and similarly, the second information may also be called the first information. It depends on a context, and for example, the word “if” used herein may be explained as “when” or “while” or “in response to determination”.

The embodiments of the present disclosure are applied to a terminal, and the terminal may be any smart terminal capable of a touch operation through a touch screen. For example, including, but not limited to, a smart phone, a tablet computer and a Personal Digital Assistant (PDA). Those skilled in the art may understand that the embodiments of the present disclosure may also be applied to any touch screen terminal with a processor and a display output device.

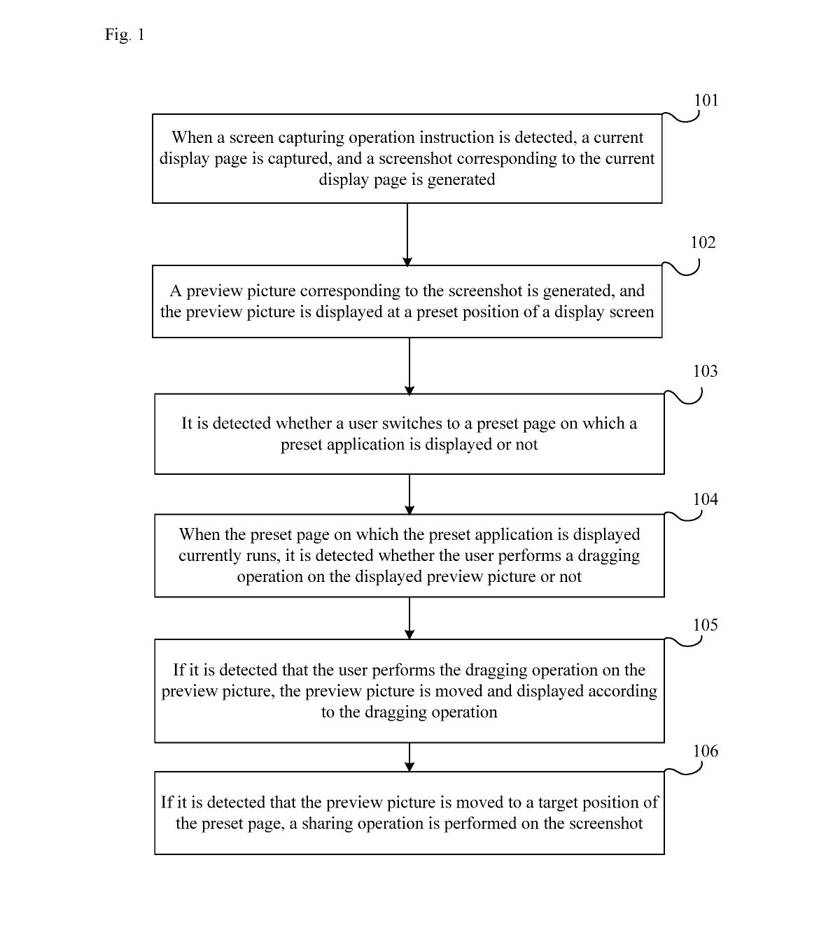

The embodiments of the present disclosure provide a content sharing method applied to the abovementioned terminal. FIG. 1 is a flow chart showing a content sharing method according to an exemplary embodiment. The method may include the following steps.

At Step 101, when a screen capturing operation instruction is detected, a current display page is captured, and a screenshot corresponding to the current display page is generated.

In an embodiment, if reading a favorite content during content browsing through the terminal, a user may reserve the favorite content in a screen capturing manner. For example, the screen capturing operation instruction may be sent to the terminal through a fast operation key or instruction. After receiving the screen capturing operation instruction, the terminal captures the current display page, and generates the screenshot corresponding to the current display page for the user. The user may perform storage, sharing or another operation on the screenshot. In an embodiment, the generated screenshot may be stored in a local picture base of the terminal as a default.

At Step 102, a preview picture corresponding to the screenshot is generated, and the preview picture is displayed at a preset position of a display screen.

In the embodiment of the present disclosure, the step that the preview picture is displayed at the preset position of the display screen may include: the preview picture is displayed at the preset position of the display screen within a preset time; and the preview picture is not displayed after the preset time expires if no operation is performed on the preview picture within the preset time.

Optionally, the step that the preview picture is displayed at the preset position of the display screen may include, but not limited to: the preview picture is displayed in a preset area of the upper right corner of the display screen; or, the preview picture is displayed in a preset area of the upper left corner of the display screen.

In such a manner, the terminal displays the preview picture of the screenshot at the preset position of the screen of the terminal to the user, and the user may see the screenshot on the current display screen without switching to the local picture base, so that the user may subsequently perform some other operations, such as marking, sharing and editing, on the screenshot conveniently.

In an embodiment, the preview picture corresponding to the screenshot may also be referred as a thumbnail corresponding to the screenshot. Either the preview picture or the thumbnail is an ingress for rapidly displaying the screenshot to the user to enable the user to rapidly view the screenshot through the preview picture or the thumbnail without switching to the local picture base for viewing. In the embodiment, the preview picture also refers to the thumbnail.

At Step 103, it is detected whether a user switches to a preset page on which a preset application is displayed.

In an embodiment, the preset application may include, but not limited to: a communication application, or a text edition application.

The text edition application may be office application software such as Word and PPT, and text edition software such as a memo and a note; and the communication application may be a communication tool such as an instant messaging application, short message service, a telephone application or Social Network Service (SNS) application software.

In an embodiment, the user may switch to the preset page on which the preset application is displayed through an application switching operation instruction.

In an embodiment, when the preset application is a communication application, the preset page may include: a contact session page in the communication application, an address book page of the communication application, or a call record interface of the communication application.

In an embodiment, when the preset application is a text edition application, the preset page may be a text edition page.

At Step 104, when the preset page on which the preset application is displayed currently runs, it is detected whether the user performs a dragging operation on the displayed preview picture.

At Step 105, if it is detected that the user performs the dragging operation on the preview picture, the preview picture is moved and displayed according to the dragging operation.

At Step 106, if it is detected that the preview picture is moved to a target position of the preset page, a sharing operation is performed on the screenshot.

In an embodiment, when the preset page is the contact session page in the communication application, the address book page of the communication application or the call record interface of the communication application, the step that the sharing operation is performed on the screenshot may include that: the screenshot is sent to a contact in the communication application to implement sharing of the screenshot. Here, the operation that the screenshot is sent to the contact in the communication application refers to that an original of the screenshot is sent to the contact in the communication application.

In an embodiment, the target position of the preset page may be: an area of a message input box of the contact session page, a position of a certain contact item in the address book page or a position of a certain call record item in the call record interface. For example, if it is detected that the preview picture is dragged and moved into the message input box of the contact session page in the communication application, the screenshot is sent to a contact of a current session; if it is detected that the preview picture is dragged and moved to a certain contact item in the address book page, the screenshot is sent to the contact; and if it is detected that the preview picture is dragged and moved to a position of a certain call record item in call records, the screenshot is sent to a contact corresponding to the call record.

In another embodiment, when the screenshot is sent to the contact in the communication application to implement sharing of the screenshot, the original of the screenshot may not be sent to the contact in the communication application. Instead, only the preview picture corresponding to the screenshot is shared to the contact, so that sharing of the screenshot may still be implemented only with a definition of the screenshot received by the contact being relatively lower, but a data volume during data communication may be reduced, and a sending speed during sharing of the screenshot may be increased when a network condition is not ideal.

In an embodiment, when the preset page is a text edition page, the step that the sharing operation is performed on the screenshot may include that: the screenshot is inserted into a text edition page to implement sharing of the screenshot.

In an embodiment, when the text edition page is a memo edition page, if it is detected that the preview picture is moved to a certain line of the memo edition page, the screenshot is inserted into the text line of the memo edition page. Alternatively, when the text edition page is office edition software, if it is detected that the preview picture is moved to a certain position of the text edition page, the screenshot is inserted to the position.

In the embodiment of the present disclosure, before the step that the sharing operation is performed on the screenshot, the method may further include that: the user is prompted whether to share the screenshot to prevent a false touch operation.

From the above, after the screenshot is generated and previewed, it is detected whether the user switches to the preset page on which the preset application is displayed; when the preset page on which the preset application is displayed currently runs, it is detected whether the user performs the dragging operation on the displayed preview picture, and if it is detected that the user performs the dragging operation on the preview picture, the preview picture is moved and displayed according to the dragging operation; and if it is detected that the preview picture is moved to the target position of the preset page, the sharing operation is performed on the screenshot. By the dragging operation on the previewed screenshot, the sharing operation on the screenshot may be rapidly implemented, thereby facilitating the operation of the user, and improving user experiences.

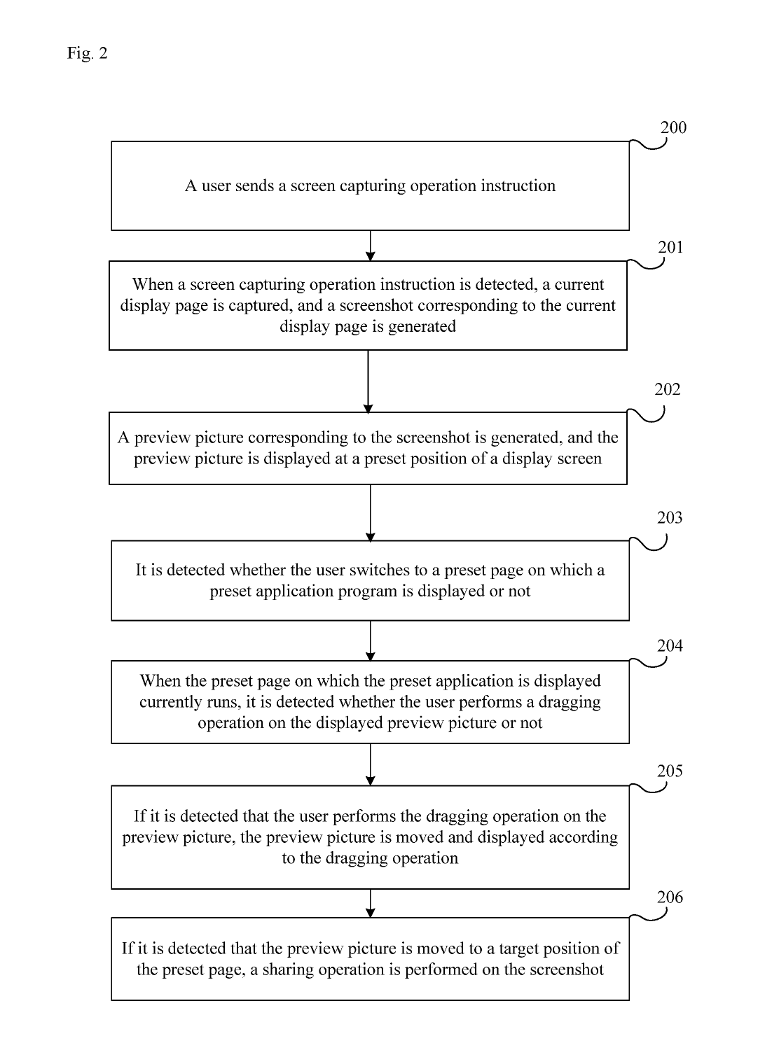

Referring to FIG. 2, FIG. 2 is a content sharing method according to an exemplary embodiment. The method is applied to the abovementioned terminal, and may include the following steps.

At Step 200, a user sends a screen capturing operation instruction.

At Step 201, when the screen capturing operation instruction is detected, a current display page is captured, and a screenshot corresponding to the current display page is generated.

In an embodiment, if reading a favorite content during content browsing through the terminal, the user may reserve the favorite content in a screen capturing manner. For example, the screen capturing operation instruction may be sent to the terminal through a fast operation key or instruction, and after receiving the screen capturing operation instruction, the terminal captures the current display page, and generates the screenshot corresponding to the current display page to the user. The user may perform storage, sharing or another operation on the screenshot. In an embodiment, the generated screenshot may be stored in a local picture base of the terminal as a default.

At Step 202, a preview picture corresponding to the screenshot is generated, and the preview picture is displayed at a preset position of a display screen.

In the embodiment of the present disclosure, the step that the preview picture is displayed at the preset position of the display screen may include: the preview picture is displayed at the preset position of the display screen within a preset time; and the preview picture is not displayed any longer after the preset time expires if no operation is performed on the preview picture within the preset time.

In an embodiment, the preset time may be set in an operating system according to a condition, for example, 2s or 3s, which is not limited in the embodiment of the present disclosure.

Optionally, the step that the preview picture is displayed at the preset position of the display screen may include, but not limited to: the preview picture is displayed in a preset area of the upper right corner of the display screen; or, the preview picture is displayed in a preset area of the upper left corner of the display screen.

In such a manner, the terminal displays the preview picture of the screenshot at the preset position of the screen of the terminal to the user, and the user may see the screenshot on the current display screen without switching to the local picture base, so that the user may subsequently perform some other operations such as marking, sharing and editing on the screenshot conveniently.

In an embodiment, the preview picture corresponding to the screenshot may also be referred as a thumbnail corresponding to the screenshot, and either the preview picture or the thumbnail is an ingress for rapidly displaying the screenshot to the user to enable the user to rapidly view the screenshot through the preview picture or the thumbnail without switching to the local picture base for viewing. In the embodiment, the preview picture also refers to the thumbnail.

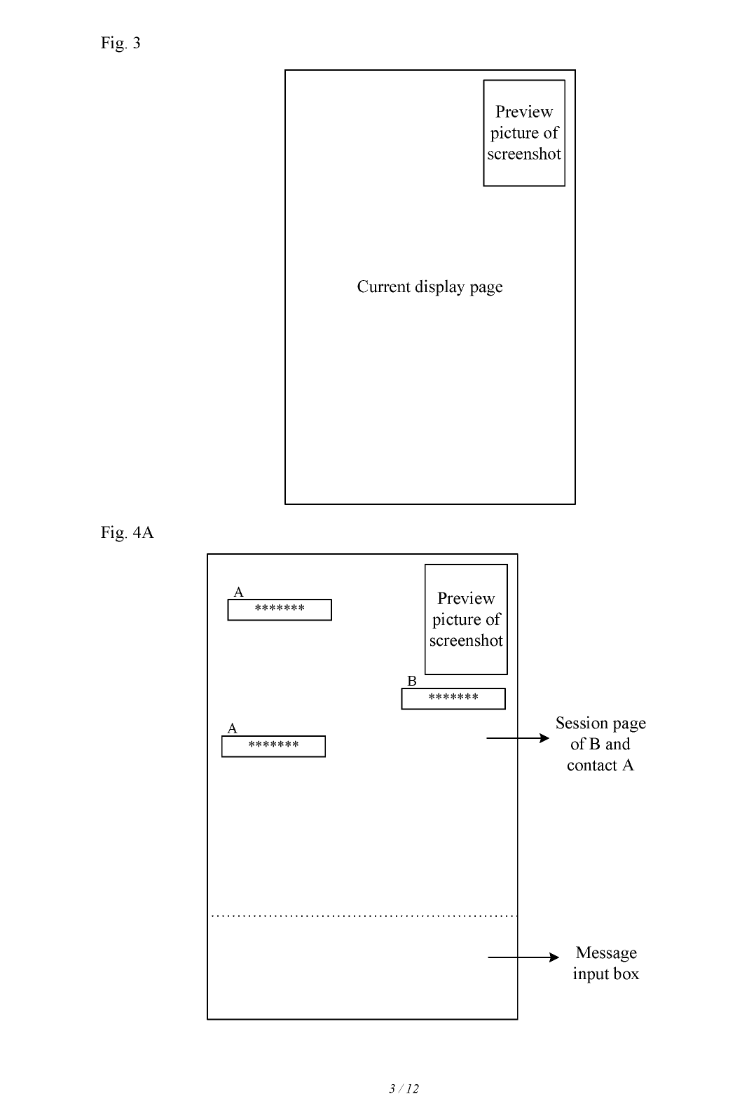

Referring to FIG. 3, FIG. 3 is a schematic diagram illustrating previewing of a screenshot on a display screen of a terminal. The preview picture of the screenshot is displayed in the preset area of the upper right corner of the display screen of the terminal. A size of the preset area is consistent with a display size of the preview picture.

At Step 203: it is detected whether the user switches to a preset page on which a preset application is displayed.

In an embodiment, the preset application may include, but not limited to: a communication application, or a text edition application.

The text edition application may be office application software such as Word and PPT, and text edition software such as a memo and a note; and the communication application may be a communication tool such as an instant messaging application, short message service, a telephone application or SNS application software.

In an embodiment, when the preset application is a communication application, the preset page may include: a contact session page in the communication application, an address book page of the communication application, or a call record interface of the communication application.

In an embodiment, when the preset application is a text edition application, the preset page may be a text edition page.

In an embodiment, the user may switch to the preset page on which the preset application is displayed through an application switching operation instruction, and when a display page switching operation instruction of the user is detected, the display page on which an application specified by the user to be displayed is displayed is switched to.

At Step 204, when the preset page on which the preset application is displayed currently runs, it is detected whether the user performs a dragging operation on the displayed preview picture.

At Step 205, if it is detected that the user performs the dragging operation on the preview picture, the preview picture is moved and displayed according to the dragging operation.

At Step 206, if it is detected that the preview picture is moved to a target position of the preset page, a sharing operation is performed on the screenshot.

In an embodiment, when the preset page is the contact session page in the communication application, the address book page of the communication application or the call record interface of the communication application, the step that the sharing operation is performed on the screenshot may include that: the screenshot is sent to a contact in the communication application to implement sharing of the screenshot. Here, the operation that the screenshot is sent to the contact in the communication application refers to that an original of the screenshot is sent to the contact in the communication application.

In an embodiment, the target position of the preset page may be: an area of a message input box of the contact session page, a position of a certain contact item in the address book page or a position of a certain call record item in the call record interface. For example, if it is detected that the preview picture is dragged and moved into the message input box of the contact session page in the communication application, the screenshot is sent to a contact of a current session.

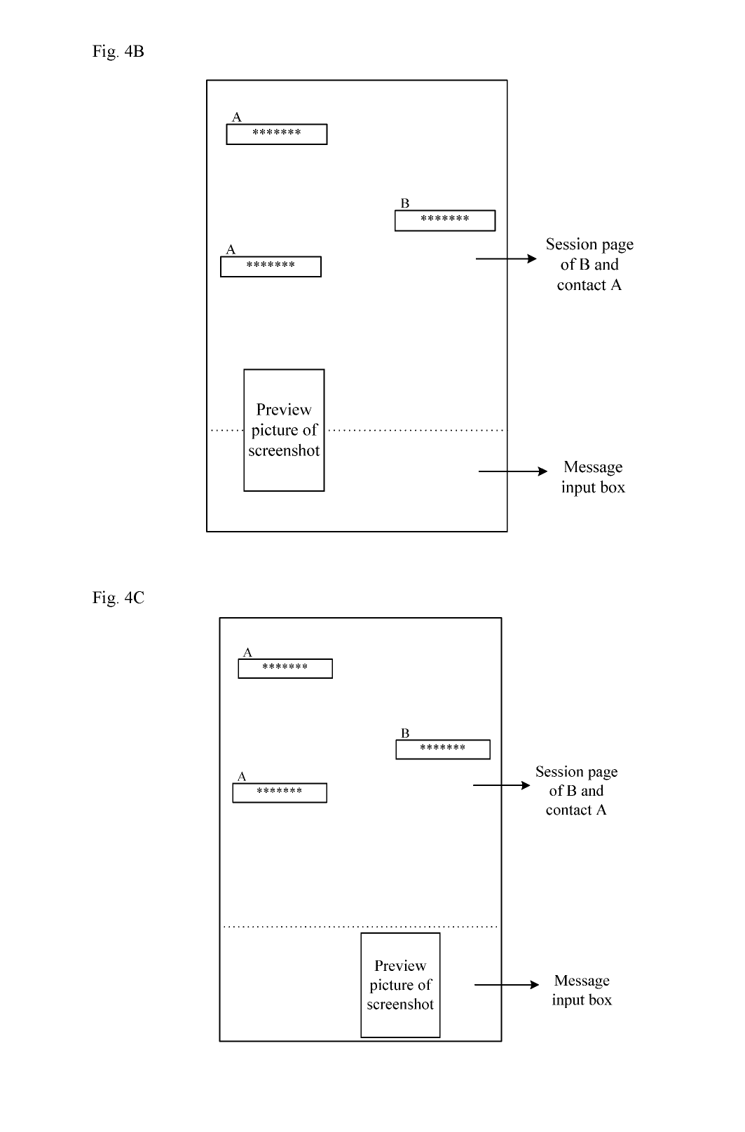

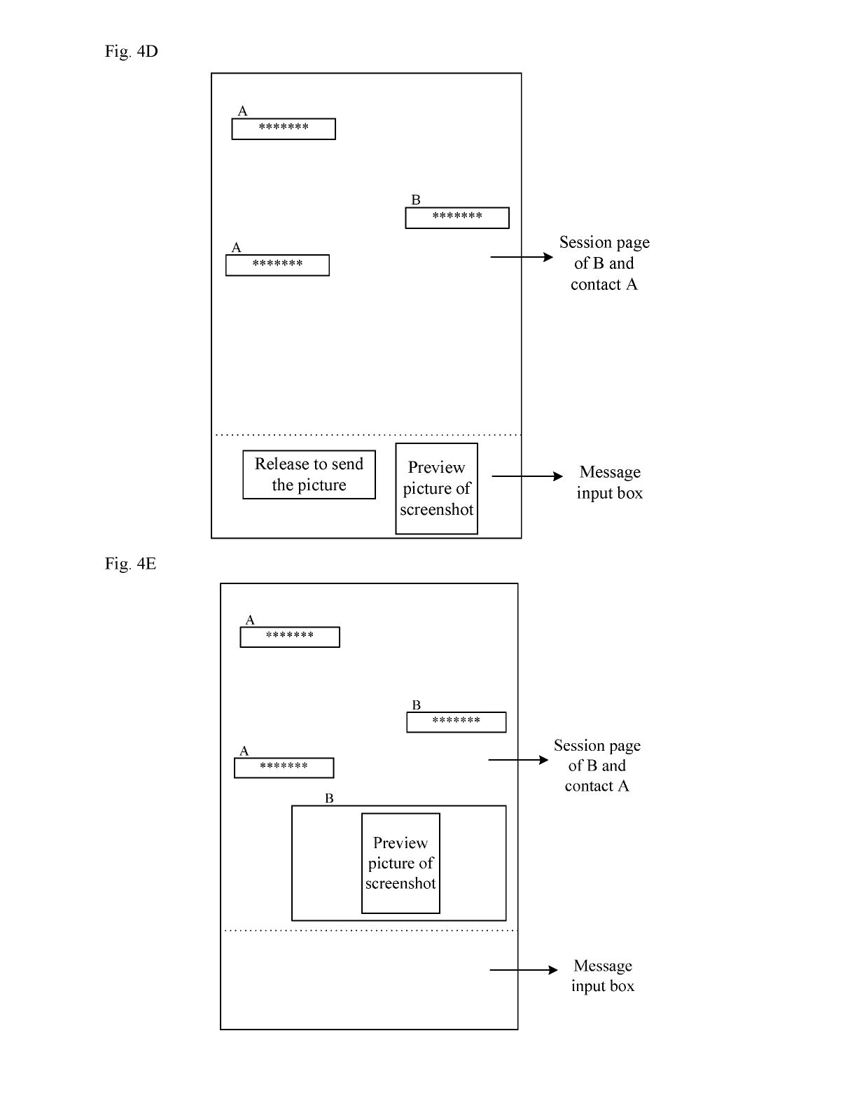

FIGS. 4A to 4E are schematic diagrams illustrating an implementation process of sharing a screenshot in a contact session page according to an exemplary embodiment. FIG. 4A is a schematic diagram illustrating a contact session page in an instant messaging application. The preview picture is displayed in the upper right corner of the display screen of the terminal; after the dragging operation of the user on the preview picture is detected, the preview picture is moved on a current display interface according to the dragging operation, and this process refers to FIG. 4B. When the preview picture is dragged into the area of the message input box of the session page, if it is detected that the user releases the preview picture, the preview picture is input into the message input box, referring to FIG. 4C. If a sending request of the user for the preview picture in the message input box is detected, the preview picture is sent to a contact of a current session, referring to FIG. 4E, to implement an operation of sharing the screenshot to the contact. In an embodiment, before the screenshot is shared to the contact, the user may be prompted to perform a picture sharing operation. As shown in FIG. 4D, the user may be prompted of words “release to send the picture” to prompt the user to release the preview picture to implement a sending operation on the screenshot.

If it is detected that the preview picture is dragged and moved to a certain contact item in the address book page, the screenshot is sent to the contact; and if it is detected that the preview picture is dragged and moved to a position of a certain call record item in call records, the screenshot is sent to a contact corresponding to the call record.

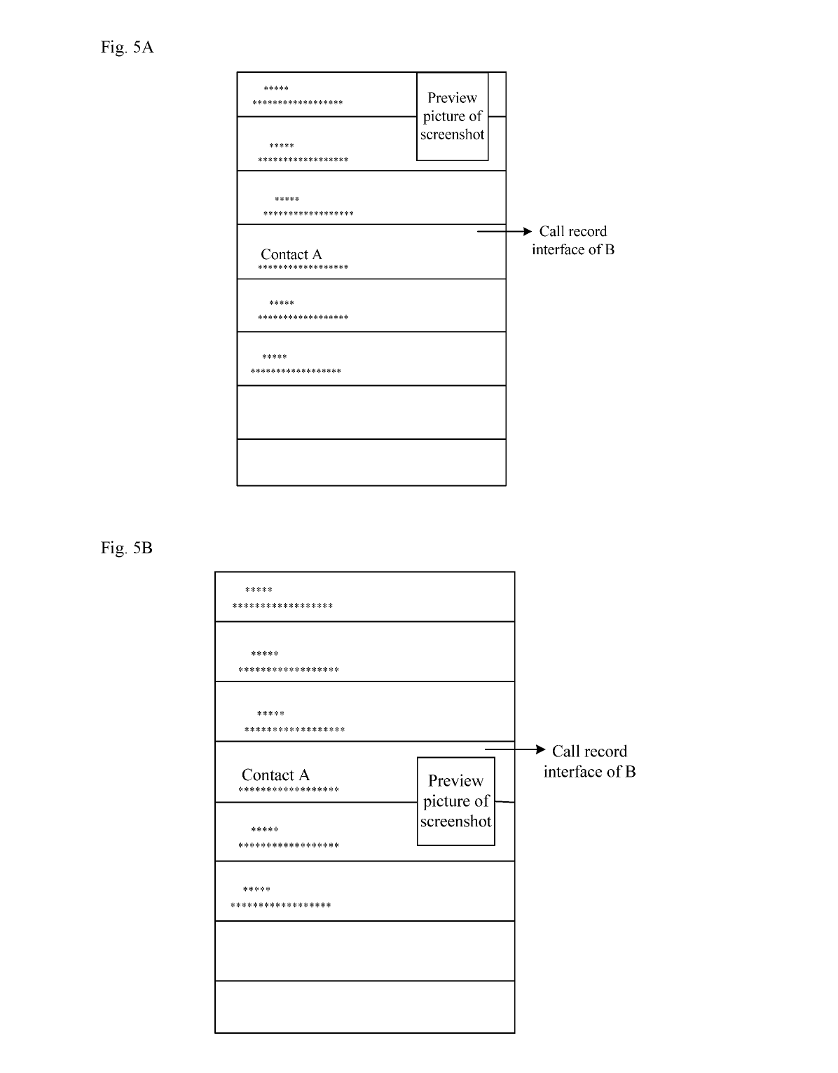

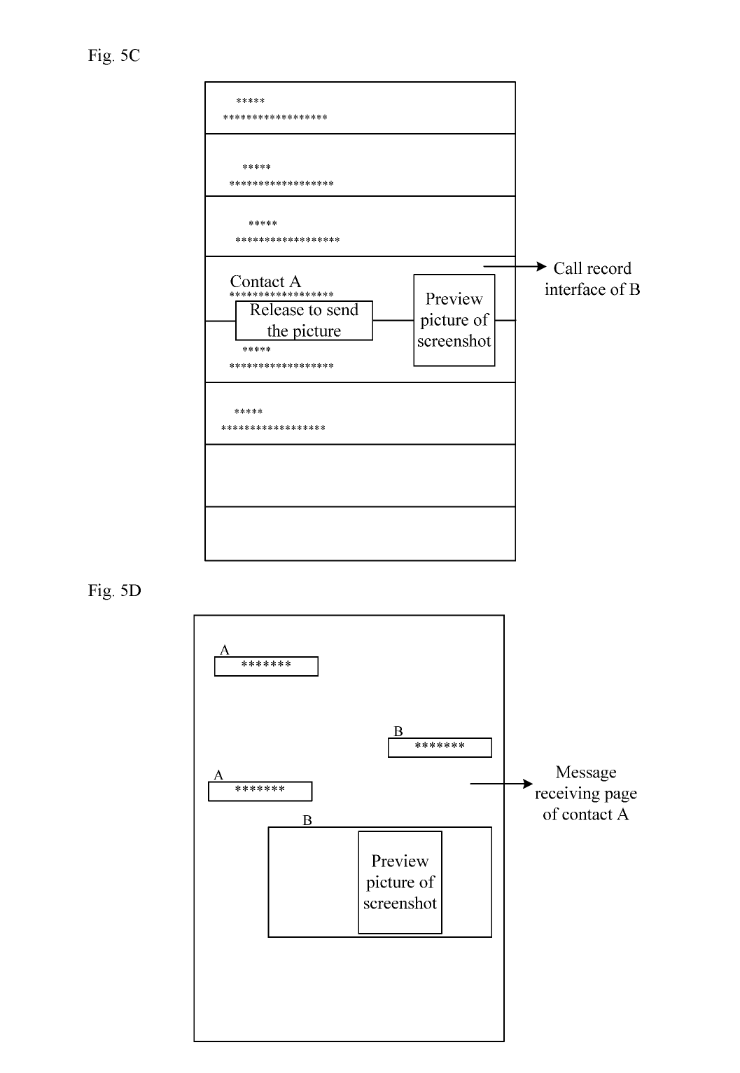

FIGS. 5A to 5D are schematic diagrams illustrating an implementation process of sharing a screenshot in a call record according to an exemplary embodiment. FIG. 5A is a schematic diagram illustrating a call record in an instant messaging application. The preview picture of the screenshot is displayed in the upper right corner of the display screen of the terminal; after the dragging operation of the user on the preview picture is detected, the preview picture is moved on the current display interface according to the dragging operation, and this process refers to FIG. 5B. When the preview picture is dragged to a certain contact item in the address book page, if it is detected that the user releases the preview picture, the screenshot is sent to the contact corresponding to the call record, referring to FIG. 5D, to implement an operation of sharing the screenshot to the contact. In an embodiment, before the screenshot is shared to the contact, the user may be prompted to perform a picture sharing operation, as shown in FIG. 5C, the user may be prompted of words “release to send the picture” to prompt the user to release the preview picture to implement a sending operation on the screenshot.

In another embodiment, when the screenshot is sent to the contact in the communication application to implement sharing of the screenshot, the original of the screenshot may not be sent to the contact in the communication application, and only the preview picture corresponding to the screenshot is shared to the contact, so that sharing of the screenshot may still be implemented only with a definition of the screenshot received by the contact being relatively lower, but a data volume during data communication may be reduced, and a sending speed during sharing of the screenshot may be increased when a network condition is not ideal.

When the preset application is another communication application, a manner for sending the screenshot to a contact in the communication application is similar to the abovementioned manner for the session page or the address book page, and will not be elaborated herein.

In an embodiment, when the preset page is a text edition page, the step that the sharing operation is performed on the screenshot may include that: the screenshot is inserted into a text edition page to implement sharing of the screenshot.

In an embodiment, when the text edition page is a memo edition page, if it is detected that the preview picture is moved to a certain line of the memo edition page, the screenshot is inserted into the text line of the memo edition page. Alternatively, when the text edition page is office edition software, if it is detected that the preview picture is moved to a certain position of the text edition page, the screenshot is inserted to the position.

In an embodiment, the original of the screenshot may be inserted into a certain position of the edition page. The preview picture corresponding to the screenshot may also be inserted into a certain position of the edition page. Since a size of the preview picture is relatively smaller, a space occupied by an edited text may be reduced.

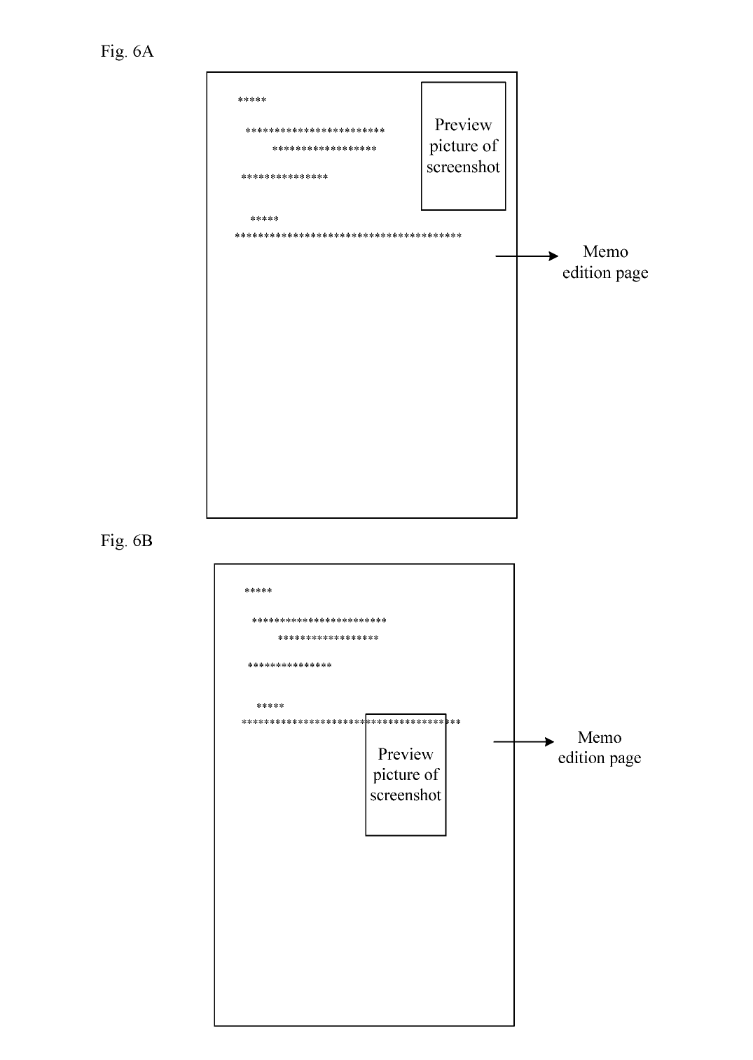

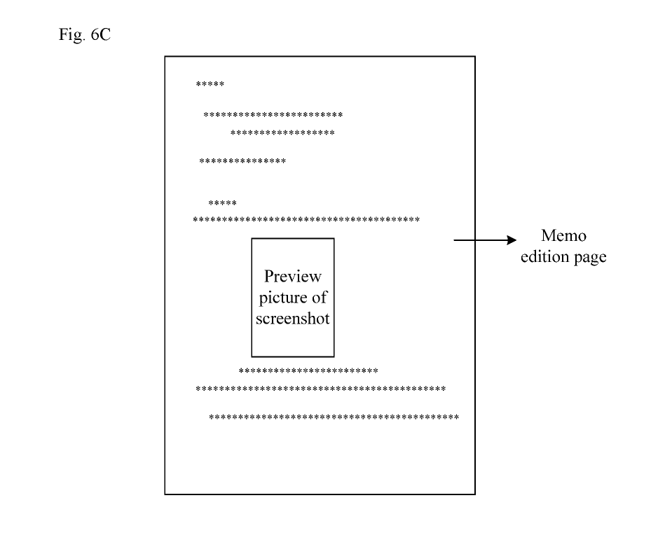

FIGS. 6A to 6C are schematic diagrams illustrating an implementation process of sharing a screenshot in a memo according to an exemplary embodiment. FIG. 6A is a schematic diagram illustrating a memo edition page. The preview picture of the screenshot is displayed in the upper right corner of the display screen of the terminal; after the dragging operation of the user on the preview picture is detected, the preview picture is moved on the current display interface according to the dragging operation, and this process refers to FIG. 6B. When the preview picture is dragged to a certain line of the memo edition page, if it is detected that the user releases the preview picture, the screenshot is inserted into the line of the memo edition page, referring to FIG. 6C, to implement sharing of the screenshot.

When the preset application is another text edition application, a manner for inserting the screenshot into a text edition page is similar to the abovementioned process of inserting the screenshot to the memo edition page, and will not be elaborated herein.

In an embodiment, the step that the sharing operation is performed on the screenshot may include that: it is detected whether a sharing triggering instruction for the screenshot is received, and if the triggering operation for the sharing operation on the screenshot is detected (for example, the dragging operation on the preview picture is detected to be released), the sharing operation is performed on the screenshot, for example, the screenshot is sent to a certain contact, or the screenshot is inserted into a certain position of the text edition page.

In an embodiment, before the step that the sharing operation is performed on the screenshot, the method may further include that: the user is prompted whether to share the screenshot to prevent a false touch operation.

From the above, after the screenshot is generated and previewed, it is detected whether the user switches to the preset page on which the preset application is displayed; when the preset page on which the preset application is displayed currently runs, it is detected whether the user performs the dragging operation on the displayed preview picture, and if it is detected that the user performs the dragging operation on the preview picture, the preview picture is moved and displayed according to the dragging operation; and if it is detected that the preview picture is moved to the target position of the preset page, the sharing operation is performed on the screenshot. By the dragging operation on the previewed screenshot, the sharing operation on the screenshot may be rapidly implemented, thereby facilitating the operation of the user, and user experiences.

The below is a device embodiment of the present disclosure, which may be configured to execute the method embodiment of the present disclosure. Details undisclosed in the device embodiment of the present disclosure refer to the method embodiment of the present disclosure.

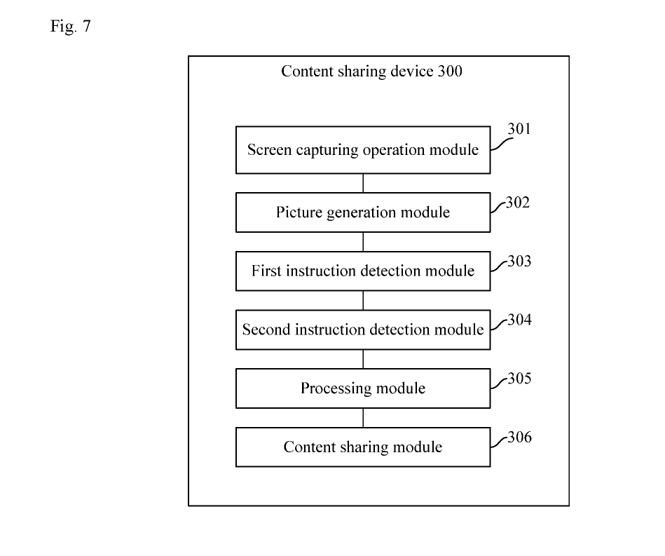

FIG. 7 is a block diagram of a content sharing device 300 according to an exemplary embodiment. The content sharing device 300 may be implemented into part or all of a terminal by virtue of software, hardware or a combination thereof, and the terminal may be electronic display equipment with a touch display screen, such as a mobile phone or a tablet computer. The content sharing device 300 may include: a screen capturing operation module 301, configured to, when a screen capturing operation instruction is detected, capture a current display page, and generate a screenshot corresponding to the current display page; a picture generation module 302, configured to generate a preview picture corresponding to the screenshot, and display the preview picture at a preset position of a display screen; a first instruction detection module 303, configured to detect whether a user switches to a preset page on which a preset application is displayed; a second instruction detection module 304, configured to, when the preset page on which the preset application is displayed currently runs, detect whether the user performs a dragging operation on the displayed preview picture; a processing module 305, configured to, if it is detected that the user performs the dragging operation on the preview picture, move and display the preview picture according to the dragging operation; and a content sharing module 306, configured to, if it is detected that the preview picture is moved to a target position of the preset page, perform a sharing operation on the screenshot.

In an embodiment, the picture generation module 302 may be configured to display the preview picture at the preset position of the display screen within a preset time, and not display the preview picture any longer after the preset time expires if no operation is performed on the preview picture within the preset time.

In another embodiment, the picture generation module 302 may be configured to display the preview picture in a preset area of the upper right corner of the display screen; or, display the preview picture in a preset area of the upper left corner of the display screen.

In an embodiment, the preset application includes: a communication application, or a text edition application.

In an embodiment, when the preset application is a communication application, the preset page includes: a contact session page in the communication application, an address book page of the communication application, or a call record interface of the communication application.

In an embodiment, the content sharing module 306 may be configured to send the screenshot to a contact in the communication application to implement sharing of the screenshot.

In an embodiment, when the preset application is a text edition application, the preset page is a text edition page.

In an embodiment, the content sharing module 306 may be configured to insert the screenshot into a text edition page to implement sharing of the screenshot.

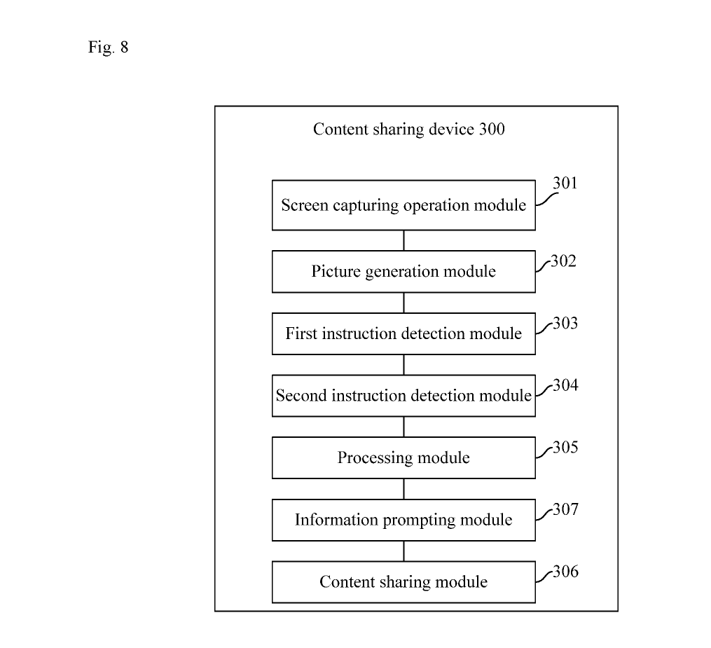

In an embodiment, referring to FIG. 8, the device shown in FIG. 7 may further include: an information prompting module 307, configured to prompt the user whether to share the screenshot.

From the above, after the screenshot is generated and previewed, it is detected whether the user switches to the preset page on which the preset application is displayed; when the preset page on which the preset application is displayed currently runs, it is detected whether the user performs the dragging operation on the displayed preview picture, and if it is detected that the user performs the dragging operation on the preview picture, the preview picture is moved and displayed according to the dragging operation; and if it is detected that the preview picture is moved to the target position of the preset page, the sharing operation is performed on the screenshot. By the dragging operation on the previewed screenshot, the sharing operation on the screenshot may be rapidly implemented, thereby facilitating the operation of the user, and improving user experiences.

With respect to the devices in the above embodiments, the specific manners for performing operations for individual modules therein have been described in detail in the embodiments regarding the methods, which will not be elaborated herein.

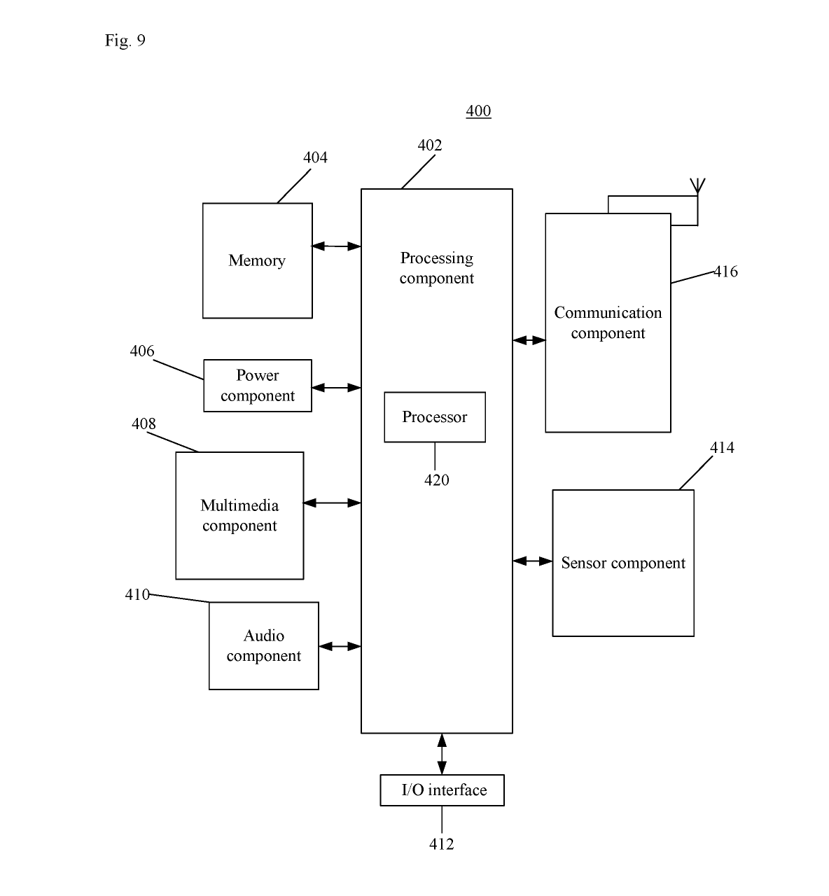

FIG. 9 is a block diagram of a content sharing device 400 according to an exemplary embodiment. For example, the device 400 may be electronic display equipment with a touch display screen, such as a mobile phone or a tablet computer.

Referring to FIG. 9, the device 400 may include one or more of the following components: a processing component 402, a memory 404, a power component 406, a multimedia component 408, an audio component 410, an Input/Output (I/O) interface 412, a sensor component 414, and a communication component 416.

The processing component 402 typically controls overall operations of the device 400, such as the operations associated with display, telephone calls, data communications, camera operations, and recording operations. The processing component 402 may include one or more processors 420 to execute instructions to perform all or part of the steps in the abovementioned content sharing method. Moreover, the processing component 402 may include one or more modules which facilitate interaction between the processing component 402 and the other components. For instance, the processing component 402 may include a multimedia module to facilitate interaction between the multimedia component 408 and the processing component 402.

The memory 404 is configured to store various types of data to support the operation of the device 400. Examples of such data include instructions for any applications or methods operated on the device 400, contact data, phonebook data, messages, pictures, video, etc. The memory 404 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 406 provides power for various components of the device 400. The power component 406 may include a power management system, one or more power supplies, and other components associated with the generation, management and distribution of power for the device 400.

The multimedia component 408 includes a screen providing an output interface between the device 400 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a duration and pressure associated with the touch or swipe action. In some embodiments, the multimedia component 408 includes a front camera and/or a rear camera. The front camera and/or the rear camera may receive external multimedia data when the device 400 is in an operation mode, such as a photographing mode or a video mode. Each of the front camera and the rear camera may be a fixed optical lens system or have focusing and optical zooming capabilities.

The audio component 410 is configured to output and/or input an audio signal. For example, the audio component 410 includes a Microphone (MIC), and the MIC is configured to receive an external audio signal when the device 400 is in the operation mode, such as a call mode, a recording mode and a voice recognition mode. The received audio signal may be further stored in the memory 404 or sent through the communication component 416. In some embodiments, the audio component 410 further includes a speaker configured to output the audio signal.

The I/O interface 412 provides an interface between the processing component 402 and a peripheral interface module, and the peripheral interface module may be a keyboard, a click wheel, a button and the like. The button may include, but not limited to: a home button, a volume button, a starting button and a locking button.

The sensor component 414 includes one or more sensors configured to provide status assessment in various aspects for the device 400. For instance, the sensor component 414 may detect an on/off status of the device 400 and relative positioning of components, such as a display and small keyboard of the device 400, and the sensor component 414 may further detect a change in a position of the device 400 or a component of the device 400, presence or absence of contact between the user and the device 400, orientation or acceleration/deceleration of the device 400 and a change in temperature of the device 400. The sensor component 414 may include a proximity sensor configured to detect presence of an object nearby without any physical contact. The sensor component 414 may also include a light sensor, such as a Complementary Metal Oxide Semiconductor (CMOS) or Charge Coupled Device (CCD) image sensor, configured for use in an imaging application. In some embodiments, the sensor component 414 may also include an acceleration sensor, a gyroscope sensor, a magnetic sensor, a pressure sensor or a temperature sensor.

The communication component 416 is configured to facilitate wired or wireless communication between the device 400 and another device. The device 400 may access a communication-standard-based wireless network, such as a Wireless Fidelity (Wi-Fi) network, a 2nd-Generation (2G) or 3rd-Generation (3G) network or a combination thereof. In an exemplary embodiment, the communication component 416 receives a broadcast signal or broadcast associated information from an external broadcast management system through a broadcast channel. In an exemplary embodiment, the communication component 416 further includes a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BlueTooth (BT) technology and another technology.

In an exemplary embodiment, the device 400 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the above mentioned display interface switching method.

In an exemplary embodiment, there is also provided a non-transitory computer-readable storage medium including instructions, such as the memory 404 including instructions, and the instructions may be executed by the processor 420 of the device 400 to implement the abovementioned content sharing method. For example, the non-transitory computer-readable storage medium may be a ROM, a Radom Access Memory (RAM), a Compact Disc Read-Only Memory (CD-ROM), a magnetic tape, a floppy disc, an optical data storage device and the like.

According to a non-transitory computer-readable storage medium, when the instructions in the storage medium are executed by the processor of the device 400, the device 400 may execute the abovementioned content sharing method.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A content sharing method, comprising:
capturing a current display page and generating a screenshot corresponding to the current display page when a screen capturing operation instruction is detected;
generating a preview picture corresponding to the screenshot and displaying the preview picture at a preset position of a display screen;
detecting whether a user switches to a preset page on which a preset application is displayed;
detecting whether the user performs a dragging operation on the displayed preview picture when the preset page on which the preset application is displayed currently runs;
moving and displaying the preview picture according to the dragging operation if it is detected that the user performs the dragging operation on the preview picture; and
performing a sharing operation on the screenshot if it is detected that the preview picture is moved to a target position of the preset page.

2. The method according to claim 1, wherein displaying the preview picture at the preset position of the display screen comprises:
displaying the preview picture at the preset position of the display screen within a preset time; and
not displaying the preview picture after the preset time expires if no operation is performed on the preview picture within the preset time.

3. The method according to claim 1, wherein displaying the preview picture at the preset position of the display screen comprises:
displaying the preview picture in a preset area of the upper right corner or the upper left corner of the display screen.

4. The method according to claim 1, wherein the preset application comprises: a communication application, or a text edition application.

5. The method according to claim 4, wherein, when the preset application is a communication application, the preset page comprises: a contact session page in the communication application, an address book page of the communication application, or a call record interface of the communication application.

6. The method according to claim 5, wherein performing the sharing operation on the screenshot comprises: sending the screenshot to a contact in the communication application.

7. The method according to claim 4, wherein, when the preset application is a text edition application, the preset page is a text edition page.

8. The method according to claim 7, wherein performing the sharing operation on the screenshot comprises:
inserting the screenshot into a text edition page.

9. The method according to claim 1, before performing the sharing operation on the screenshot, further comprising: prompting the user whether to share the screenshot.

10. A content sharing device, comprising:
a processor; and
a memory configured to store instructions executable by the processor,
wherein the processor is configured to:
capture a current display page and generate a screenshot corresponding to the current display page when a screen capturing operation instruction is detected;
generate a preview picture corresponding to the screenshot and display the preview picture at a preset position of a display screen;
detect whether a user switches to a preset page on which a preset application is displayed;
detect whether the user performs a dragging operation on the displayed preview picture, when the preset page on which the preset application is displayed currently runs;
move and display the preview picture according to the dragging operation if it is detected that the user performs the dragging operation on the preview picture; and
perform a sharing operation on the screenshot if it is detected that the preview picture is moved to a target position of the preset page.

11. The device according to claim 10, wherein the processor configured to display the preview picture at the preset position of the display screen is further configured to:
display the preview picture at the preset position of the display screen within a preset time; and
not display the preview picture after the preset time expires if no operation is performed on the preview picture within the preset time.

12. The device according to claim 10, wherein the processor configured to display the preview picture at the preset position of the display screen is further configured to:
display the preview picture in a preset area of the upper right corner or the upper left corner of the display screen.

13. The device according to claim 10, wherein the preset application comprises: a communication application, or a text edition application.

14. The device according to claim 13, wherein when the preset application is a communication application, the preset page comprises: a contact session page in the communication application, an address book page of the communication application, or a call record interface of the communication application.

15. The device according to claim 14, wherein the processor configured to perform the sharing operation on the screenshot is further configured to:
send the screenshot to a contact in the communication application.

16. The device according to claim 13, wherein, when the preset application is a text edition application, the preset page is a text edition page.

17. The device according to claim 16, wherein the processor configured to perform the sharing operation on the screenshot is further configured to:
insert the screenshot into a text edition page.

18. The device according to claim 10, wherein the processor is further configured to prompt the user whether to share the screenshot.

19. A non-transitory computer-readable storage medium having stored therein instructions that, when executed by a processor of a terminal, causes the terminal to perform a content sharing method, the method comprising:
capturing a current display page and generating a screenshot corresponding to the current display page when a screen capturing operation instruction is detected;
generating a preview picture corresponding to the screenshot and displaying the preview picture at a preset position of a display screen;
detecting whether a user switches to a preset page on which a preset application is displayed;
detecting whether the user performs a dragging operation on the displayed preview picture when the preset page on which the preset application is displayed currently runs;
moving and displaying the preview picture according to the dragging operation if it is detected that the user performs the dragging operation on the preview picture; and
performing a sharing operation on the screenshot if it is detected that the preview picture is moved to a target position of the preset page.
